(19) United States
(12) Patent Application Publication
(10) Pub. No.: US 2005/0236353 A1
(43) Pub. Date: Oct. 27, 2005

(54) Flatulency-preventing device associated with nursing bottle

(76) Inventor: William Hsu, Taipei (TW)

Correspondence Address: William Hsu, 7., No. 213, Civic Boulevard. Sec. 4, Taipei, 105, TW

(21) Appl. No.: 10/835,145

(22) Filed: Apr. 27, 2004

(51) Int. Cl. A61J 9/04; A61J 11/02; A61J 9/08

(52) U.S. Cl. 215/11.5; 215/11.6

(57) ABSTRACT

A flatulency-preventing device is associated with a nursing bottle, and includes a fluid guide fitted between a nipple and a body of the nursing bottle to define a one-direction flowing path in the bottle, and an air bubble collector fitted around a lower rim of the fluid guide to locate in the body of the nursing bottle. Air rushing into the bottle at the instant of releasing of the sucked nipple is guided into the air bubble collector via the fluid guide to gather up at a bottom of the nursing bottle without mixing with the fluid in the bottle and being sucked into a baby's stomach to cause undesirable flatulency.

### FIELD OF THE INVENTION

The present invention relates to a flatulency-preventing device associated with a nursing bottle. The flatulency-preventing device employs the principle that gas in a fluid automatically floats to a high position of the fluid, and defines a one-direction path for the fluid in a nursing bottle, so as to avoid air entered the bottle from mixing with the fluid and being sucked into a baby's stomach to cause flatulency.

### BACKGROUND OF THE INVENTION

A nursing bottle typically includes a body defining a single inner space, and a nipple having an air hole provided at a top thereof. When a baby sucks the nipple, air will rush into the nipple via the still opened air hole at the instant the sucked nipple is released, and forms slowly floating bubbles in the nursing bottle. Some of the bubbles are pulled into the fluid in the nursing bottle when the baby sucks the nipple again, and enter the baby's stomach along with the fluid to cause flatulency. Therefore, it is necessary to pat the baby's back after each feeding with a nursing bottle, in order to expel air from the baby's stomach. Many attempts have been made by nursing bottle manufacturers to overcome this problem. However, most past attempts are focused on the smooth guiding of air entered the nursing bottle via the air hole on the nipple. As a matter of fact, air always rushes into the nursing bottle at the instant of releasing of the nipple after one sucking and mixes with the fluid flown back into the bottle at the same time. The air entered the nursing bottle forms bubbles that gradually float on the fluid. Therefore, it is desirable to work out a way for the air entered the nursing bottle to float out of the fluid without mixing with the latter and being sucked into the baby's stomach to cause flatulency.

### SUMMARY OF THE INVENTION

A primary object of the present invention is to provide a flatulency-preventing device associated with a nursing bottle to protect a baby against undesirable flatulency after being fed with the nursing bottle.

To achieve the above and other objects, the flatulency-preventing device of the present invention includes a fluid guide fitted between a nipple and a body of the nursing bottle to define a one-direction path in the bottle, and an air bubble collector fitted around a lower rim of the fluid guide to locate in the body of the nursing bottle. Air entered into the nursing bottle at the instant of releasing of the sucked nipple is guided into the air bubble collector via the fluid guide to gather up at a bottom of the nursing bottle without mixing with the fluid in the bottle and being sucked into a baby's stomach to cause undesirable flatulency.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a nursing bottle having a flatulency-preventing device of the present invention associated therewith;

FIG. 2 is an exploded perspective view of the nursing bottle of FIG. 1;

FIG. 3 is a sectioned perspective view of the nursing bottle of FIG. 1;

FIG. 4 is a cross sectional view of the nursing bottle of FIG. 1 showing the position at where the sectioned perspective view of FIG. 3 is taken; and

FIG. 5 is another sectioned perspective view of the nursing bottle of FIG. 1 showing the manner in which the flatulency-preventing device functions.

### DETAILED DESCRIPTION OF THE PREFERRED EMBODIMENTS

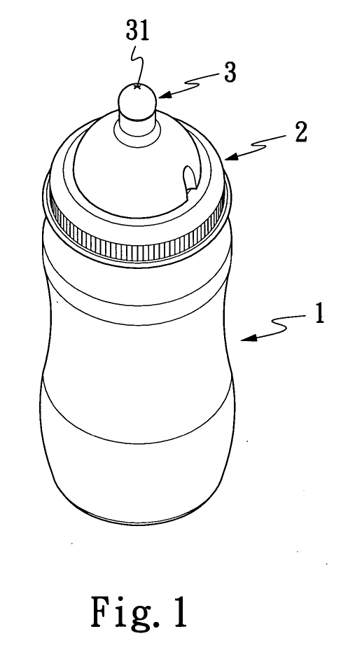

Please refer to FIG. 1 that is a perspective view of a nursing bottle having a flatulency-preventing device of the present invention associated therewith. The nursing bottle is basically structurally similar to general nursing bottles to include a body 1, a cap 2, and a nipple 3 having an air hole 31 provided at a top thereof. However, the nursing bottle of FIG. 1 is characterized in a unique flatulency-preventing device mounted therein as a flow guiding mechanism.

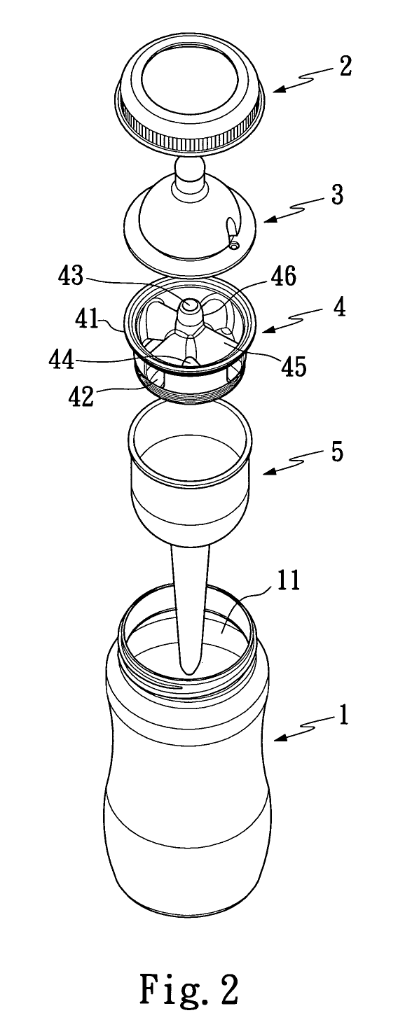

FIG. 2 is an exploded perspective view of the nursing bottle of FIG. 1. As shown, the flatulency-preventing device is fitted in the body 1 of the nursing bottle below the cap 2 and the nipple 3 and includes a fluid guide 4 and an air bubble collector 5. With the flatulency-preventing device fitted in the body 1, an inner chamber 11 defined by the body 1 is made to allow a fluid in the nursing bottle to circulate in only one direction.

The fluid guide 4 is substantially a ring member having an annular wall. The fluid guide 4 mainly includes a flange 41 radially outward extended from an upper rim of the annular wall, an upward projected hollow central hub 46 defining a top outlet 43, and one or more connecting bars 45 radially extended between the central hub 46 and the annular wall. The connecting bars 45 are hollow members, each of which has a radially outer end defining a lower inlet 42 on the annular wall. The lower inlets 42 are communicable with the top outlet 43 of the central hub 46. Spaces in the fluid guide 4 between the annular wall and the central hub 46 and the connecting bars 45 are formed into backflow through holes 44. The number of the backflow holes 44 depends on the number of the connecting bars 45. The air bubble collector 5 is fitted around a lower rim of the annular wall of the fluid guide 4, and includes an expanded upper portion serving as a bubble-collecting chamber 51 and a reduced and downward tapered lower tubular portion adapted to extend to a point close to an inner bottom of the body 1 of the nursing bottle.

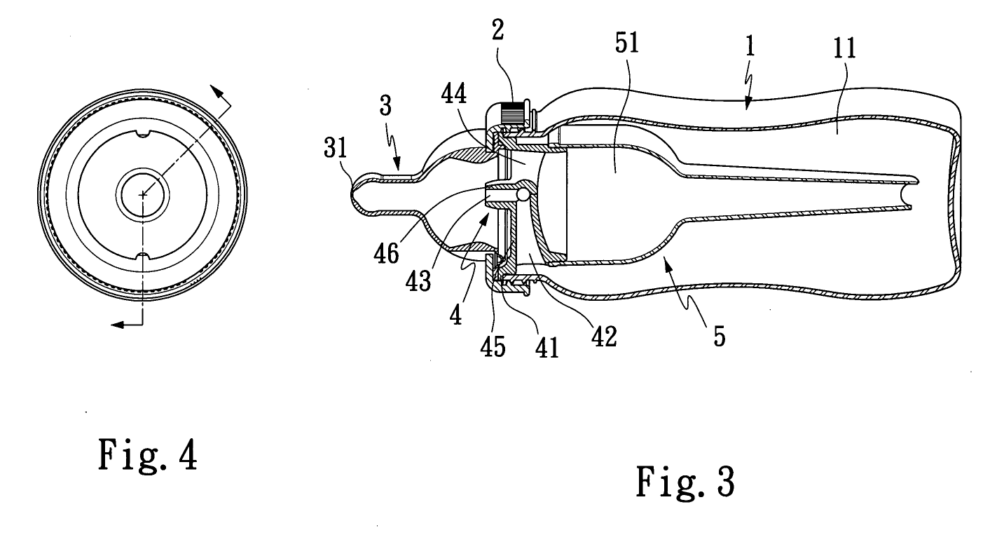

FIG. 3 is a sectioned perspective view of the nursing bottle of FIG. 1 with the flatulency-preventing device of the present invention. FIG. 4 is a cross sectional view of the nursing bottle of FIG. 1 showing the position at where the sectional perspective view of FIG. 3 is taken. As shown in FIG. 3, the nipple 3 and the inner chamber 11 of the body 1 together constitute a complete space inside the nursing bottle with the fluid guide 4 located between the nipple 3 and the body 1 to separate the complete space of the nursing bottle into two parts. The air bubble collector 5 is fitted around the lower rim of the fluid guide 4 with a lower end of the reduced lower tubular portion located close to the bottom of the inner chamber 11. The inner chamber 11 is communicable with the top outlet 43 via the lower inlets 42 of the connecting bars 45 on the annular wall of the fluid guide 4. The top outlet 43 is upward projected into a hollow interior of the nipple 3. The backflow holes 44 defined in the fluid guide 4 is located at a level lower than that of the inlets 42, and communicate the bubble-collecting chamber 51 of the air bubble collector 5 with the nipple 3. The backflow holes 44 are communicable with the bottom of the inner chamber 11 of the nursing bottle via the downward extended tubular portion of the air bubble collector 5.

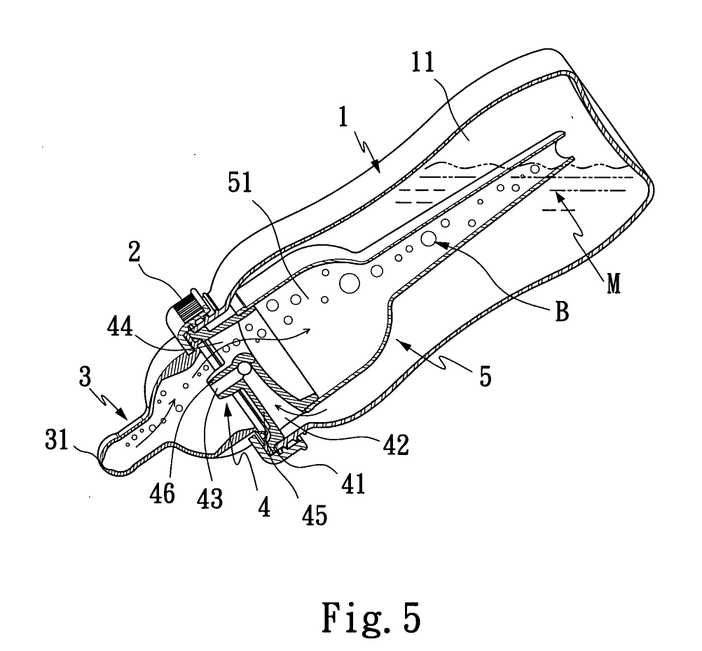

FIG. 5 shows the nursing bottle with the flatulency-preventing device of the present invention in an inclined position suitable for sucking by a baby (not shown). When the nipple 3 is sucked and released, air instantaneously rushes into the nipple 3 via the air hole 31 and quickly forms bubbles B in the nipple 3 having a fluid M flown thereto. Since the bubbles B are lighter than the fluid M in the nipple 3 and therefore float to a higher side of the inclined nursing bottle. At the instant of releasing of the sucked nipple 3, bubbles B quickly pass through the backflow holes 44 into the bubble-collecting chamber 51 and gradually gather up while floating out into the reduced tubular portion of the air bubble collector 5. When the nipple 3 is sucked again, the fluid M without bubbles B is induced to the top outlet 43 of the central hub 46 via the lower inlets 42 on the annular wall of the fluid guide 4, and finally flows to the air hole 31 on the nipple 3.

Tests have been conducted on samples of the present invention and it is proven the flatulency-preventing device of the present invention effectively prevents air bubbles entered the nursing bottle from mixing with the fluid in the bottle while feeding a baby with the nursing bottle. The baby is therefore protected against undesirable flatulency that would normally occur when the baby is fed with the conventional nursing bottle.

1. A flatulency-preventing device associated with nursing bottle, said nursing bottle including a body and a nipple fitted to a top of the body via a cap, said flatulency-preventing device comprising a fluid guide fitted in said nursing bottle between said body and said nipple, and an air bubble collector connected to a lower end of said fluid guide to locate in said body of said nursing bottle;
said fluid guide being a ring member having an annular wall with a radially outward extended flange formed along an upper rim thereof, and including an upward projected hollow central hub defining a top outlet, and at least one connecting bar radially extended between said central hub and said annular wall; said connecting bar being a hollow member with a radially outer end defining a lower inlet on said annular wall to communicate with said top outlet; spaces in said fluid guide defined between said annular wall and said central hub and said at least one connecting bar functioning as backflow through holes; and
said air bubble collector being fitted around a lower rim of said annular wall of said fluid guide, and including an expanded upper bubble-collecting chamber and a reduced and downward tapered tubular portion below said bubble-collecting chamber, with a lower end of said tubular portion of said air bubble collector located close to an inner bottom of said body of said nursing bottle;
whereby said fluid guide and said air bubble collector together function as a flow guiding mechanism to guide the fluid in said nursing bottle into the nipple via said lower inlets of said connecting bars on said annular wall and said top outlet on said central hub, while guiding air entered said nipple into said air bubble collector via said backflow through holes, so that air bubbles formed by the air entered said nursing bottle do not mix with the fluid in said nursing bottle to be sucked into a baby's stomach.

2. The flatulency-preventing device associated with nursing bottle as claimed in claim 1, wherein said fluid guide includes at least two said connecting bars.
